(19) United States
(12) Patent Application Publication
(10) Pub. No.: US 2006/0282656 A1
(43) Pub. Date: Dec. 14, 2006

(54) Computer system and method of controlling power consumption in the computer system

(75) Inventor: Jeom-jin Chang, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co, Ltd., Suwon-si (KR)

(21) Appl. No.: 11/444,469

(22) Filed: Jun. 1, 2006

(30) Foreign Application Priority Data
Jun. 1, 2005 (KR) 2005-46795

(51) Int. Cl. G06F 15/177

(52) U.S. Cl. 713/1

(57) ABSTRACT

A computer system that includes: an installing unit to which an external device is installed to support either a first interface or a second interface; an external device controller which includes a first controller to communicate with the external device when installed to the installing unit, via the first interface, and a second controller to communicate with the external device when installed to the installing unit, via the second interface; an external device determiner to determine an interface supported by the external device installed to the installing unit; and a controlling unit to control the external device controller to disable a controller communicating through the interface that is not supported by the external device installed to the installing unit, based on a determination result from the external device determiner during a POST operation. Thus, a computer system is provided to promote saving system resources and power consumption.

### CROSS-REFERENCE TO RELATED APPLICATIONS

This application claims the benefit of Korean Patent Application No. 2005-46795, filed on Jun. 1, 2005, in the Korean Intellectual Property Office, the disclosure of which is incorporated herein by reference.

### BACKGROUND OF THE INVENTION

1. Field of the Invention

Aspects of the invention relate to a computer system, and, more particularly, to a computer system which saves system resources and power consumption.

2. Description of the Related Art

A computer system has been developed in line with a high-speed processing capability of a central processing unit (CPU) and a high-speed bus, such as PCI-Express, USB2.0 and IEEE 1394 type buses. However, a parallel advanced technology attachment (PATA) is fixed to 133 MB/s at a maximum. To overcome such a limitation associated with the parallel advanced technology attachment (PATA), a serial advanced technology attachment (SATA) has been introduced. The SATA can operate at a speed of 1.5 Gbps at a maximum. Further, the SATA-II, can operate at a speed of 3.0 Gbps. The SATA or SATA-II typically communicates through a communication cable which employs 4 signal pins, thereby occupying small space in a board.

With such an advantage in speed, a SATA hard disc drive (HDD), which supports SATA or SATA-II, is becoming more widely used, as well as the continued use of the existing PATA hard disc drive (HDD). In this regard, conventional computer systems typically have both a SATA controller and a PATA controller.

A small-sized computer system, such as a notebook computer, typically employs both the SATA controller and the PATA controller. However, the small-sized computer system generally uses either the SATA HDD or the PATA HDD due to spatial limitations.

In the computer system which employs either the SATA HDD or the PATA HDD, a basic input/output system (BIOS) performs a power-on self-test (POST) operation when power is turned on and supplied to the computer system. During the POST operation, both the SATA controller and the PATA controller are enabled and initialized. Also, during a device initializing process of the SATA controller and the PATA controller, the SATA and PATA controllers typically receive system resources such as an input/output (I/O) range, a memory range and an interrupt. Further, the BIOS determines whether the SATA HDD or the PATA HDD is installed to the computer system, and initializes the installed hard disc drive (HDD).

The conventional computer system controls the installed hard disc drive (HDD) (e.g., SATA HDD) through communication with the SATA controller. Also, in the conventional computer system, the SATA controller or the PATA controller is initialized during the POST operation, and is usually not used in operation of the computer system, but typically remains enabled and continues to consume the received system resources, even though it is not used in operation of the computer system, thereby consuming power unnecessarily.

### SUMMARY OF THE INVENTION

Several aspects and example embodiments of the invention provide a computer system which promotes a saving of system resources and power consumption.

In accordance with an embodiment of the present invention, a computer system includes: an installing unit to install an external device to support a first interface or a second interface; an external device controller including a first controller to communicate with the external device when installed to the installing unit, via the first interface, and a second controller to communicate with the external device when installed to the installing unit, via the second interface; an external device determiner to determine the first interface or the second interface supported by the external device when installed to the installing unit; and a controlling unit to control the external device controller to disable the first controller or the second controller communicating through the interface that is not supported by the external device when installed to the installing unit, based on a determination result from the external device determiner during a POST operation.

According to an aspect of the invention, the external device includes a hard disk drive (HDD) to support the first interface or the second interface. According to another aspect of the invention, the external device controller includes an input/output control hub (ICH) which includes the first controller and the second controller.

According to other aspects of the invention, the external device determiner includes: a predetermined installing pin among a plurality of signal pins of the installing unit to receive a first installing signal from the external device, when the external device supporting the first interface is installed to the installing unit, and to receive a second installing signal from the external device, when the external device supporting the second interface is installed to the installing unit; and a general purpose input/output (GPIO) to output a determination signal to the controlling unit after determining the external device is installed to the first interface or the second interface of the installing unit, according to the first installing signal or the second installing signal transmitted through the installing pin of the first interface or the second interface.

According to further aspects of the invention, the computer system further includes: a clock signal generator to generate a clock signal to supply to the second controller, wherein the controlling unit includes a BIOS to disable the clock signal generator and the second controller, when the external device supporting the first interface is installed to the installing unit, and to disable the first controller, when the external device supporting the second interface is installed to the installing unit, based on the determination signal from the GPIO device, during the POST operation.

Also, according to aspects of the invention, the first interface supports a parallel advanced technology attachment (PATA) standard and the second interface supports a serial advanced technology attachment (SATA) standard, and wherein the external device includes a PATA hard disc drive (HDD) to support the PATA standard or a SATA hard disc drive (HDD) to support the SATA standard. Further, according to aspects of the invention, the first controller includes a PATA controller to communicate with the PATA HDD and the second controller includes a SATA controller to communicate with the SATA HDD.

Additional aspects and/or advantages of the invention are set forth in the description which follows or are evident from the description, or can be learned by practice of the invention.

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIG. 1 is a control block diagram of a computer system according to the invention; and

FIG. 2 is a control flowchart of the computer system according to the invention.

### DETAILED DESCRIPTION OF THE EMBODIMENTS

Reference will now be made in detail to embodiments of the invention, examples of which are illustrated in the accompanying drawings, wherein like reference numerals refer to the like elements throughout. The embodiments are described below in order to explain aspects of the invention by referring to the figures, with well-known functions or constructions not necessarily being described in detail.

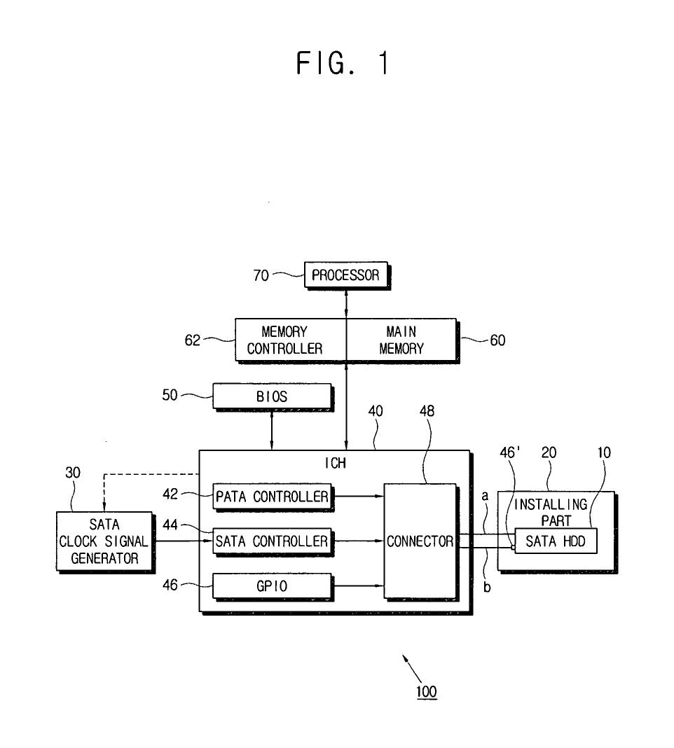

FIG. 1 is a control block diagram of a computer system 100 according to an embodiment and aspects of the invention. As shown in FIG. 1, the computer system 100 includes an installing unit 20 to install an external device, such as a SATA HDD 10 or a PATA HDD, therein to support either a first interface or a second interface of the installing unit 20. The computer system 100 also includes an input/output control hub (ICH) 40 as an external device controller to determine an interface, such as the first interface or the second interface, supported by the external device installed to the installing unit 20, and includes a parallel advanced technology attachment (PATA) controller as a first controller 42 which communicates with the external device installed to the installing unit 20, via the first interface, and a serial advanced technology attachment (SATA) controller as a second controller 44 which communicates with the external device, via the second interface. Also, the ICH 40, the first controller 42 and the second controller 44 can be any suitable processing device, a chipset or incorporated within an application specific integrated circuit (ASIC), with associated memory and software or programming, to perform the respective operations of the ICH 40, the first controller 42 and the second controller 44 in the computer system 100.

The computer system 100 further includes a SATA clock signal generator 30 to generate a SATA clock signal to supply to the SATA controller 44, and a BIOS as a controlling unit 50 to control the external device controller 40, such as the input/output control hub (ICH), to disable the PATA controller 42 or the SATA controller 44 communicating through an interface, such as the first interface or the second interface, that is not supported by the external device installed to the installing unit 20, based on a determination result from the ICH 40 during a POST operation.

In an example embodiment and according to aspects of the invention, the first interface includes a communication interface to support a parallel advanced technology attachment (PATA) standard; and the second interface includes a communication interface to support a serial advanced technology attachment (SATA) standard. The first interface includes the PATA communication interface, and the second interface includes the SATA communication interface, but the invention is not limited in this regard. Alternatively, the first interface and the second interface can include various other suitable communication interfaces that are typically used in computer technology having different communication interfaces.

The external device which is installed to the installing unit 20 includes, for example, a PATA HDD supporting the PATA standard, and/or a SATA HDD 10 supporting the SATA standard, or other suitable external device. As shown in FIG. 1, for example, the SATA HDD 10, when installed, is installed to the installing unit 20. While the external device installed to the installing unit 20 includes the PATA HDD, that supports the PATA standard, and the SATA HDD 10, that supports the SATA standard, as an example in the embodiment of FIG. 1, the invention is not limited in this regard. Alternatively, the external device can be any suitable external device that is selectively installable to the installing unit 20 to support the first interface or the second interface, as the communication interfaces, which typically respectively have, or support, different standards or different communication interfaces.

The ICH 40 also includes a general purpose input/output (GPIO) 46 to determine the interface, such as the first interface or the second interface, that is supported by the external device installed to the installing unit 20. The ICH 40 further includes the PATA controller 42 as the first controller to communicate with the PATA HDD, when installed to the installing unit 20, and also includes the SATA controller 44 as the second controller to communicate with the SATA HDD 10 when installed to the installing unit 20. The ICH 40 selectively enables or disables the SATA controller 44 to communicate with the SATA HDD 10, and communicates with the SATA clock signal generator 30 to generate the SATA clock signal supplied to the SATA controller 44, through the control of the BIOS 50. Also, the ICH 40 selectively enables or disables the PATA controller 42 to communicate with the PATA HDD, through the control of the BIOS 50. In the example embodiment, the PATA controller 42 and the SATA controller 44 are provided as a PCI device or a PCI-Express device, but the invention is not limited in this regard.

The general purpose input/output (GPIO) 46 includes an external device determiner to determine the interface, such as the first interface or the second interface, supported by the external device, such as a hard disc drive (HDD) installed to the installing unit 20. The external device determiner includes a predetermined installing pin 46′ among a plurality of signal pins provided in the installing unit 20, to receive a first installing signal from the PATA HDD when the PATA HDD is installed to the installing unit 20, and to receive a second installing signal from the SATA HDD 10 when the SATA HDD 10 is installed to the installing unit 20. The general purpose input/output (GPIO) 46 outputs a determination signal to the BIOS 50 after or in response to determining the corresponding interface of the hard disc drive (HDD), or other suitable external device, installed to the installing unit 20, according to the respective first or second installing signals transmitted through the installing pin 46′. In the example embodiment shown in FIG. 1, the installing pin 46′ and the GPIO 46 including the external device determiner are provided in the installing unit 20 and the ICH 40, respectively. Alternatively, the installing pin 46′ and the GPIO 46 including the external device determiner can be additionally provided, instead of being included with the above components.

A connector 48 of the ICH 40 includes an interface connector with which a communication cable is connected to communicate with the corresponding hard disc drive (HDD), or other external device, installed to the installing unit 20. The SATA HDD 10, as an external device, communicates through the communication cable which typically uses 4 signal pins. The PATA HDD, as an external device, communicates through the communication cable which typically use 40 signal pins. Accordingly, the installing unit 20 and the ICH 40 respectively communicate through the communication cable with typically 45 lines including 40 communication lines for the PATA HDD, 4 communication lines for the SATA HDD 10 and one communication line to receive the installing signal from the corresponding hard disc drive (HDD), or other suitable external device, installed to the installing unit 20. The connector 48 includes the interface connector with a suitable number of pins to accommodate the various external devices that are installed to the installing unit 20, such having 45 pins, for example.

When the power is turned on to supply the power to the computer system 100, the BIOS 50 performs the POST operation. At the beginning of the POST operation, the BIOS 50 initializes various components of the computer system 100 including a processor 70, such as a central processing unit (CPU), and a memory controller 62, associated with a main memory 60, with the memory controller 62 communicating with the processor 70, and the GPIO 46. The processor 70 can be any suitable processing device, such as a processor, microprocessor or an application specific integrated circuit (ASIC), with associated memory and software or programming, to control the operations of the computer system 100. The memory 60 can include a suitable memory, such as a read only memory (ROM) and a random access memory (RAM), with the memory controller 62 being a suitable controller to control processes and operations of the memory 62.

Also, in performing the POST operation, the SATA controller 44 and the PATA controller 42 are initialized. While performing the POST operation, the BIOS 50 determines the type of the hard disc drive (HDD), such as the PATA HDD or the SATA HDD 10, or other suitable external device, installed to the installing unit 20, based on the determination signal input from the GPIO 46. When the SATA HDD 10 is installed to the installing unit 20 as shown in FIG. 1, the ICH 40 communicates typically through 4 communication lines (a) for the SATA HDD 10 and one communication line (b) to receive the installing signal among the communication cable with 45 communication lines.

In the example embodiment, the BIOS 50 controls the ICH 40 to disable the PATA controller 42 when it is determined that the SATA HDD 10 is installed to the installing unit 20 as shown in FIG. 1, based on the determination signal input from the GPIO 46. Further, the BIOS 50 distributes system resources, such as input/output (I/O) ranges, memory ranges and an interrupt, to the SATA controller 44 through the device (PCI or PCI-Express) initializing process for the SATA controller 44, when the SATA HDD 10 is installed to the installing unit 20. The PATA controller 42 which is disabled before the device (PCI or PCI-Express) initializing process does not receive the system resources, when the SATA HDD 10 is installed to the installing unit 20.

Further, when the PATA HDD is installed to the installing unit 20, the BIOS 50 controls the ICH 40 to disable the SATA controller 44 and the SATA clock signal generator 30 to distribute the system resources, such as the I/O ranges, the memory ranges and the interrupt, to the PATA controller 42 through the device (PCI or PCI-Express) initializing process. At this time, the SATA controller 44, which is disabled before the device (PCI or PCI-Express) initializing process, does not receive the system resources, when the PATA HDD is installed to the installing unit 20. In this regard, the BIOS 50 determines and initializes the SATA HDD 10 or the PATA HDD, or other suitable external device, when installed to the installing unit 20, to respectively drive the SATA HDD 10 or the PATA HDD, or other suitable external device, in an operating system (OS) after performing the POST operation.

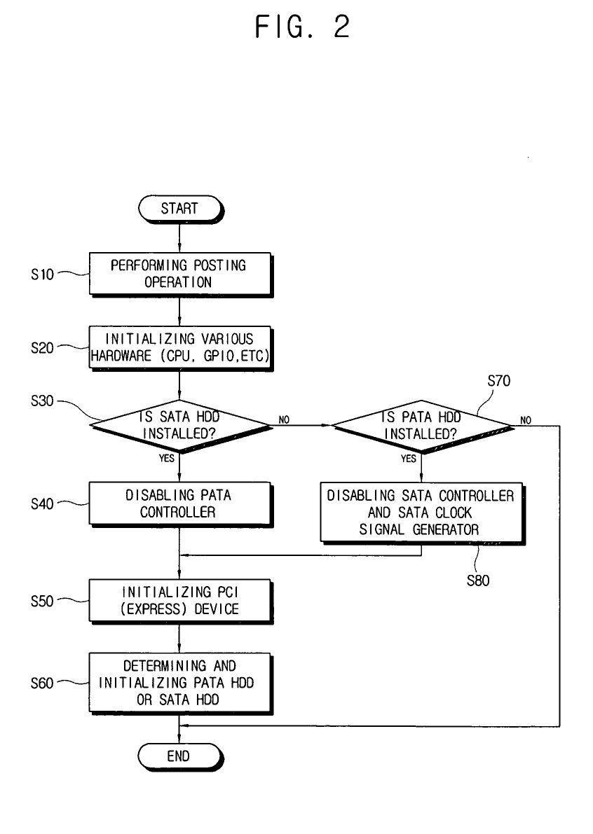

Referring to FIG. 2, a control flow operation of the computer system 100, according to an example embodiment and aspects of the invention, is described. First, the BIOS 50 performs the POST operation when the power is turned on to supply the power to the computer system 100 (operation S10). At the beginning of the POST operation, the BIOS 50 initializes various hardware or components of the computer system 100, such as the central processing unit (CPU) or processor 70, the memory 60 and the general purpose input/output (GPIO) device 46 (operation S20). Also, the SATA controller 44 and the PATA controller 42 are initialized at operation S20.

While performing the POST operation, the BIOS 50 determines whether the SATA HDD 10 is installed to the installing unit 20 based on the determination signal input from the GPIO 46 (operation S30). When it is determined that the SATA HDD 10 is installed to the installing unit 20, the BIOS 50 controls the ICH 40 to disable the PATA controller 42 (operation S40). Then, the BIOS 50 distributes the system resources, such as the I/O ranges, the memory ranges and the interrupt, to the SATA controller 44 through the device (PCI or PCI-Express) initializing process for the SATA controller 44 (operation S50). The BIOS 50 determines and initializes the SATA HDD 10 installed to the installing unit 20 to drive the SATA HDD 10 in the operating system (OS) after performing the POST operation (operation S60).

When it is determined that the SATA HDD 10 is not installed to the installing unit 20 at operation S30, the BIOS 50 determines whether the PATA HDD is installed to the installing unit 20 based on the determination signal input from the GPIO 46 (operation S70). When it is determined that the PATA HDD is installed to the installing unit 20, the BIOS 50 controls the ICH 40 to disable the SATA controller 44 and the SATA clock signal generator 30 (operation S80). Then, the BIOS 50 distributes the system resources, such as the I/O ranges, the memory ranges and the interrupt, to the PATA controller 42 through the device (PCI or PCI-Express) initializing process for the PATA controller 42 (operation S50). The BIOS 50 determines and initializes the PATA HDD installed to the installing unit 20, thereby driving the PATA HDD in the OS after performing the POST operation (operation S60). Where neither the PATA HDD nor the SATA HDD 10 is installed to the installing unit 20, the operation proceeds to end.

According to the foregoing and other aspects of the invention, a computer system according to the invention, such as the computer system 100, disables the respective controller, such as the PATA controller 42, the SATA controller 44, or other suitable external device controller, which does not communicate through the corresponding interface supported by the external device, and which is not used, in view of the type of the interface supported by the external device, such as a hard disc drive (HDD), installed to the installing unit 20, during the POST operation. Thus, a computer system according to the invention disables an unnecessary controller, such as the PATA controller 42 or the SATA controller 44, before performing the device (PCI or PCI-Express) initializing process for the PATA controller 42 or the SATA controller 44, thereby promoting a saving of the system resources and preventing unnecessary power consumption in the operation of the computer system.

The foregoing embodiments, aspects and advantages are merely exemplary and are not to be construed as limiting the invention. Also, the description of the embodiments of the invention is intended to be illustrative, and not to limit the scope of the claims, and various other alternatives, modifications, and variations will be apparent to those skilled in the art. For example, although the external device has been described as either a PATA HDD which supports the PATA standard or a SATA HDD which supports the SATA standard, the invention can also apply to other suitable external devices used with a computer system, or other type of processing or control system, to promote a savings of power consumption. Also, according to aspects of the invention, the first interface and the second interface, as predetermined interfaces, can also be integrated into a single, or unitary, interface to receive a plurality of external devices. Therefore, although a few embodiments of the invention have been shown and described, it would be appreciated by those skilled in the art that changes may be made in the embodiments without departing from the principles and spirit of the invention, the scope of which is defined in the claims and their equivalents.

What is claimed is:

1. A computer system, comprising:
an installing unit to install an external device to support a first interface or a second interface of the computer system;
an external device controller including a first controller to communicate with the external device installed to the installing unit, via the first interface, and a second controller to communicate with the external device installed to the installing unit, via the second interface;
an external device determiner to determine the first interface or the second interface supported by the external device, when the external device is installed to the installing unit; and
a controlling unit to control the external device controller to disable the first controller communicating via the first interface or the second controller communicating via the second interface, that is not supported by the external device installed to the installing unit, based on a determination result from the external device determiner during a power-on self-test (POST) operation of the computer system.

2. The computer system according to claim 1, wherein:
the external device comprises a hard disk drive (HDD) to support the first interface or the second interface.

3. The computer system according to claim 2, wherein:
the external device controller comprises an input/output control hub (ICH) that includes the first controller and the second controller.

4. The computer system according to claim 3, wherein:
the external device determiner comprises a predetermined installing pin among a plurality of signal pins, the installing unit to receive a first installing signal from the external device, when the external device supporting the first interface is installed to the installing unit, and to receive a second installing signal from the external device, when the external device supporting the second interface is installed to the installing unit; and
a general purpose input/output (GPIO) to output a determination signal to the controlling unit to indicate the first interface or the second interface being supported by the external device, according to the first installing signal or the second installing signal transmitted through the corresponding installing pin.

5. The computer system according to claim 4, further comprising:
a clock signal generator to generate a clock signal to selectively supply the clock signal to the second controller, and wherein
the controlling unit comprises:
a basic input/output system (BIOS) to disable the clock signal generator and the second controller, when it is determined that the external device supporting the first interface is installed to the installing unit, and the BIOS to disable the first controller, when it is determined that the external device supporting the second interface is installed to the installing unit, based on the determination signal from the GPIO, during the POST operation of the computer system.

6. The computer system according to claim 5, wherein:
the first interface supports a parallel advanced technology attachment (PATA) standard,
the second interface supports a serial advanced technology attachment (SATA) standard, and
the external device comprises either a PATA hard disc drive (HDD) to support the PATA standard or a SATA hard disc drive (HDD) to support the SATA standard.

7. The computer system according to claim 6, wherein:
the first controller comprises a PATA controller to communicate with the PATA HDD, and
the second controller comprises a SATA controller to communicate with the SATA HDD.

8. The computer system according to claim 2, wherein:
the external device determiner comprises a predetermined installing pin among a plurality of signal pins, the installing unit to receive a first installing signal from the external device, when the external device supporting the first interface is installed to the installing unit, and to receive a second installing signal from the external device, when the external device supporting the second interface is installed to the installing unit; and
a general purpose input/output (GPIO) to output a determination signal to the controlling unit to indicate the first interface or the second interface being supported by the external device, according to the first installing signal or the second installing signal transmitted through the corresponding installing pin.

9. The computer system according to claim 8, further comprising:
a clock signal generator to generate a clock signal to selectively supply the clock signal to the second controller, and wherein
the controlling unit comprises:
a basic input/output system (BIOS) to disable the clock signal generator and the second controller when it is determined that the external device supporting the first interface is installed to the installing unit, and the BIOS to disable the first controller when it is determined that the external device supporting the second interface is installed to the installing unit, based on the determination signal from the GPIO, during the POST operation of the computer system.

10. The computer system according to claim 9, wherein:
the first interface supports a parallel advanced technology attachment (PATA) standard,
the second interface supports a serial advanced technology attachment (SATA) standard, and
the external device comprises a PATA hard disc drive (HDD) to support the PATA standard or a SATA hard disc drive (HDD) to support the SATA standard.

11. The computer system according to claim 10, wherein:
the first controller comprises a PATA controller to communicate with the PATA HDD, and
the second controller comprises a SATA controller to communicate with the SATA HDD.

12. The computer system according to claim 1, wherein:
the external device determiner comprises a predetermined installing pin among a plurality of signal pins, the installing unit to receive a first installing signal from the external device, when the external device supporting the first interface is installed to the installing unit, and to receive a second installing signal from the external device, when the external device supporting the second interface is installed to the installing unit; and
a general purpose input/output (GPIO) to output a determination signal to the controlling unit to indicate the first interface or the second interface being supported by the external device, according to the first installing signal or the second installing signal transmitted through the corresponding installing pin.

13. The computer system according to claim 12, further comprising:
a clock signal generator to generate a clock signal to selectively supply the clock signal to the second controller, and wherein
the controlling unit comprises:
a basic input/output system (BIOS) to disable the clock signal generator and the second controller, when it is determined that the external device supporting the first interface is installed to the installing unit, and the BIOS to disable the first controller, when it is determined that the external device supporting the second interface is installed to the installing unit, based on the determination signal from the GPIO, during the POST operation of the computer system.

14. The computer system according to claim 13, wherein:
the first interface supports a parallel advanced technology attachment (PATA) standard,
the second interface supports a serial advanced technology attachment (SATA) standard, and
the external device comprises either a PATA hard disc drive (HDD) to support the PATA standard or a SATA hard disc drive (HDD) to support the SATA standard.

15. The computer system according to claim 14, wherein:
the first controller comprises a PATA controller to communicate with the PATA HDD, and
the second controller comprises a SATA controller to communicate with the SATA HDD.

16. The computer system according to claim 1, wherein:
the first interface supports a parallel advanced technology attachment (PATA) standard,
the second interface supports a serial advanced technology attachment (SATA) standard,
the external device comprises a PATA hard disc drive (HDD) to support the PATA standard or a SATA hard disc drive (HDD) to support the SATA standard,
the first controller comprises a PATA controller to communicate with the PATA HDD, and
the second controller comprises a SATA controller to communicate with the SATA HDD.

17. A computer system, comprising:
a first controller to communicate with an external device when installed via a first interface to the computer system,
a second controller to communicate with the external device when installed via a second interface to the computer system; and
a controlling unit to selectively disable the first controller communicating via the first interface or second controller communicating via the second interface, that is not supported by the external device, when the external device is installed to the computer system.

18. The computer system according to claim 17, further comprising:
an external device determiner configured to receive a first installing signal or a second installing signal from the external device, the external device determiner including a predetermined installing pin to receive the first installing signal from the external device, when the external device supporting the first interface is installed to the computer system, and to receive the second installing signal from the external device, when the external device supporting the second interface is installed to the computer system; and
a general purpose input/output (GPIO) to output a determination signal to the controlling unit to indicate the first interface or the second interface being supported by the external device, according to the first installing signal or the second installing signal transmitted via the corresponding installing pin.

19. The computer system according to claim 17, further comprising:
an external device determiner configured to receive a first installing signal from the external device, when the external device supporting the first interface is installed to the computer system, and to receive a second installing signal from the external device, when the external device supporting the second interface is installed to the computer system; and
a general purpose input/output (GPIO) to output a determination signal to the controlling unit to indicate the first interface or the second interface being supported by the external device, according to the first installing signal or the second installing signal from the external device.

20. The computer system according to claim 19, wherein:
the first interface supports a parallel advanced technology attachment (PATA) standard,
the second interface supports a serial advanced technology attachment (SATA) standard, and
the external device comprises either a PATA hard disc drive (HDD) to support the PATA standard or a SATA hard disc drive (HDD) to support the SATA standard.

21. The computer system according to claim 20, further comprising:
a clock signal generator to generate a clock signal to selectively supply the clock signal to the second controller, and wherein
the controlling unit comprises:
a basic input/output system (BIOS) to disable the clock signal generator and the second controller, when it is determined that the external device is supporting the first interface and installed to the computer system, and the BIOS to disable the first controller, when it is determined that the external device is supporting the second interface and installed to the computer system, based on the determination signal from the GPIO, during a power-on self-test (POST) operation of the computer system.

22. The computer system according to claim 17, wherein:
the first interface supports a parallel advanced technology attachment (PATA) standard,
the second interface supports a serial advanced technology attachment (SATA) standard, and
the external device comprises either a PATA hard disc drive (HDD) to support the PATA standard or a SATA hard disc drive (HDD) to support the SATA standard.

23. A method of controlling power consumption in a computer system, comprising:
installing an external device via a first interface or a second interface to the computer system;
determining which of the first interface or the second interface is installed to the external device, when the external device is installed to the computer system, to provide a determination result; and
selectively disabling a first controller of the computer system communicating via the first interface or a second controller of the computer system communicating via the second interface, that is not supported by the external device installed to the computer system, based on the determination result.

24. The method of controlling power consumption in a computer system according to claim 23, wherein:
the determining which of the first interface or the second interface is installed to the external device occurs during a power-on self-test (POST) operation of the computer system.

25. The method of controlling power consumption in a computer system according to claim 24, wherein:
the first interface supports a parallel advanced technology attachment (PATA) standard,
the second interface supports a serial advanced technology attachment (SATA) standard, and
the external device comprises either a PATA hard disc drive (HDD) to support the PATA standard or a SATA hard disc drive (HDD) to support the SATA standard.

26. The method of controlling power consumption in a computer system according to claim 23, wherein:
the first interface supports a parallel advanced technology attachment (PATA) standard,
the second interface supports a serial advanced technology attachment (SATA) standard, and
the external device comprises either a PATA hard disc drive (HDD) to support the PATA standard or a SATA hard disc drive (HDD) to support the SATA standard.
